(19) United States
(12) Patent Application Publication
(10) Pub. No.: US 2003/0139907 A1
(43) Pub. Date: Jul. 24, 2003

(54) System, Method, and Product for Nanoscale Modeling, Analysis, Simulation, and Synthesis (NMASS)

(76) Inventor: Robert J McCarthy, Everett, MA (US)

(21) Appl. No.: 10/248,092

(22) Filed: Dec. 17, 2002

Related U.S. Application Data
(60) Provisional application No. 60/350,808, filed on Jan. 24, 2002.

(51) Int. Cl. G06F 15/00; G06F 11/30

(52) U.S. Cl. 702/183

(57) ABSTRACT

### Abstract of Disclosure

A computer-based system is described that provides users with the ability to develop high-fidelity digital quantitative representations of physical and chemical phenomena, and to employ an optimization-based approach to control associated physiochemical processes. The system includes a computational environment, intuitive user interface(s), integrated software libraries, analytical tools, and visualization/rendering engine that together provide an integrated framework for nanoscale modeling, analysis, simulation, and synthesis. Additionally, the system includes an optimal linear control synthesis methodology that incorporates a first order dynamic mathematical representation (of the conceptual molecular system) suitable for applying various pragmatic control system techniques including optimization of structured singular values, linear quadratic performance functions, Lyapunov criteria, or similar, for the purposes of nanoscale fabrication and molecular assembly.

### Cross Reference To Related Applications

Parent Case Text: This application claims the benefit of U.S. Provisional Application No. 60/350,808, filed Jan. 24, 2002, which is commonly owned and the contents of which are expressly incorporated herein by reference.

### Background of Invention

The invention relates generally to the simulation of organic and inorganic material characteristics at the atomic and molecular scale, and the combinatorial processes and mathematical models representing these materials and their reactive properties. In particular, the invention relates to scientific computer software and stochastic discrete modeling of material structure and function at nanoscale resolution (including quantum mechanics and aggregate physiochemical characteristics), and an associated control system based methodology for precision nanoscale fabrication and molecular assembly.

Miniaturization and the advancement of manipulation of matter on a molecular scale are key technical imperatives for many foreseeable product and technology development efforts. Advancement in electronics, fuel cells, new energy sources, smart materials, bio-engineered pharmaceuticals, genetics and disease prevention, all require molecular scale simulation and synthesis. Even recognizing the progress in recent years with electronic density, material purity, precision assembly, and protein synthesis, the pursuit of further advancements in scale and control will most certainly remain a priority for decades to come.

Prior art has been established in related areas. In particular, prior art scientific software applications are known in computational chemistry, material science mathematical modeling, quantum mechanics simulation, microfabrication and modern biotechnology. However, much of the related prior art focuses on a particular aspect of molecular modeling or employs an iterative empirical methodology, but does not directly relate to the integration of closed-loop analytical control methods with computer-implemented simulation and synthesis procedures that explicitly include rigorous mathematical treatment of quantum mechanics and aggregate material structure and function. Much of the prior art therefore has limitations with respect to its application or extensibility to precision nanoscale fabrication and molecular assembly, particularly for generalized utility.

The particular novelty of the described invention is the unique combination of quantum mechanical modeling and analysis tools integrated together with two distinct approaches for optimal linear control system design. This powerful combination results in a fundamental framework to employ established but otherwise unrelated engineering design methods from macroscale electromechanical manufacturing with nanoscale fabrication and molecular assembly (e.g., geometric tolerancing, six sigma, design for assembly/test).

The following examples of established prior art are cited for comparison.

U.S. Pat. No. 6,421,612 describes an iterative empirical methodology and computer program for identifying chemical compounds having desired properties. The system identifies a set of compounds for analysis; collects, acquires or synthesizes the identified compounds; analyzes the compounds to determine one or more physical, chemical and/or bioactive properties (structure-property data); and uses the structure-property data to identify another set of compounds for analysis in the next iteration.

U.S. Pat. No. 6,014,449 describes a computer-implemented system for analyzing the rigidity of substructures within a molecule represented as atomic coordinate and bond data. The system includes a preprocessor and specialized data structures to achieve computational efficiency.

U.S. Pat. No. 6,219,440 describes a method to simulate biological material by acquiring an n-dimensional geometric description of the material, linking biological features to a model defining physiological properties, specifying a set of mathematical equations corresponding to processes, associating features with a region within the geometric description, and creating a set of elements to simulate physiological processes.

U.S. Pat. No. 5,553,004 describes a constrained stochastic dynamical method for simulating the motion of a molecular system. The method simulates the motions of atoms within the molecular system by evaluating first order force expressions for all the atoms over a series of time steps. The force expressions include terms for frictional forces, non-covalent interatomic forces, thermal noise forces, and covalent constraining forces. Because the method treats the movement of atoms within a molecular system as over-damped, the atomic force balances are first order force expressions that can be evaluated without iteration.

Still other related prior art focus specifically on particular applications of nanotechnology, as opposed to an integrated set of nanoscale simulation and synthesis tools including particular control synthesis techniques to achieve the desired precision. Related examples include a molecular computer (US 6,430,511), a molecular field programmable gate array (US 6,215,327), a nanowire array (US 6,359,288), and a self-organizing control system using genetic optimization of differential entropy production (US 6,411,944).

Due to the technological complexity of accurately modeling static and dynamic behavior at the scale of atomic and molecular structure, related prior art and commercially available physiochemical scientific modeling software generally require substantial computational resources and therefore remain primarily limited to highly advanced academic and industry research facilities. To date, this basic limitation has presented impedances to commercialization objectives by restricting availability from a much broader community of potential contributors.

As a result, due to the specialized nature of related research, in contrast with simulation and synthesis methodologies developed for macroscale design (e.g., automotive vehicle dynamics, aerospace structures), prior art scientific software for nanoscale simulation and synthesis has not generally been developed to systematically include customizable or re-programmable driver interfaces for integrating various specialized sensory hardware capable of real-time nanoscale data capture (e.g., scanning probe, electromagnetic, mass spectroscopic, enhanced optical, or other relevant hardware technologies, many of which are advancing increasingly toward real-time capabilities). Recent advances with such devices achieve sub-nanometer resolution in 3 dimensions with topographic imaging and structural information, with a trend toward real-time. Hence, there are significant limitations in the prior art related to the direct application of hardware-in-the-loop real-time validation and verification techniques that are widely practiced for models at larger scale.

Still further, although much technological advancement has been accomplished in the field of visual presentation by means of electronic media, integration of such visualization tools with the prior art in related scientific computing packages generally requires advanced user skills in computer programming in addition to expertise in particular fields of research (e.g., quantum physics, chemistry, biology). Significant possibilities exist for innovation in simplifying the integration of visualization technologies through embedded integration with the nanoscale simulation and synthesis scientific software tools.

Ultimately, the end objective of nanoscale fabrication and molecular assembly, and the associated analytical and computational tools that define the present state-of-the-art, is to facilitate what shall be termed herein as "synthesis" - the ability to provide closed loop control to simulated results and empirical experimentation. In this context, nanoscale synthesis is an enabling technology that serves as the critical foundation for achieving precision molecular manufacturing to desired designer specifications. In general, prior art in this area focuses on empirically driven results from physiochemical experimentation and precision-tolerance bulk process based manufacturing.

By way of specific example, diamondoids are nanoscale diamond fragments comprising carbon atom lattices with highly strong tetrahedral chemical bond structures. Present practical applications for diamondoids include some limited pharmaceutical products, however, many more nanoscale electronic and mechanical applications have been contemplated by industry technologists for years, with limited availability to synthesize and assemble such applications for practical use. This invention proposes a system and methodology to help overcome the limiting factors for such nanoscale synthesis and assembly.

With the rapid rate of progression of modern computational power, memory, and data storage being made available with desktop personal computers and client server network architectures, whether considering a single machine or a distributed grid processing model, an opportunity has emerged for innovative powerful new tools that combine various information related technologies together with intuitive user interfaces and scientific computing software to achieve unprecedented advancement in nanoscale modeling, analysis, simulation, and synthesis.

### Summary of Invention

It is therefore a principal object of the invention to provide a set of computational software tools that deliver to users intuitive fields, controls, hardware drivers, and database structures to facilitate nanoscale modeling, analysis, simulation, and synthesis through the unique combination of quantum mechanics and applied stochastic control mathematics. It is another principal object of this invention that these software tools enable mathematical, behavioral, and functional modeling and characterization of physical and chemical phenomena including inorganic, organic, and/or hybrids. It is yet another principal object of this invention that the proposed tools provide capability for model aggregation and time sequencing for the purposes of dynamic analysis, simulation, prediction, and visualization, while inherently considering the nanoscale quantum underpinnings of the results. It is yet another principal object of this invention to include mathematical representation of both quantum and classical mechanics, and extensions to fully comprehensive bottom-up descriptions of bulk material processing (e.g., microfabrication). It is yet another principal object of this invention to provide real-time data capture and closed-loop control for material synthesis through the physiochemical manipulation of matter at a nanoscale level of fidelity. It is yet another principal object of the invention to provide compatibility with other related scientific software products and hardware devices, many of which are applicable to larger scale or have particular focus on a specific industry vertical.

Accordingly, the present invention features a combination of advanced mathematics from quantum theory, chemical physics, stochastic analysis, and optimal control, together with an architecture sufficiently flexible to accomplish diverse industry applications by connecting to different databases, installing specialized templates, and integrating with related sensor and synthesis hardware. The invention builds from one core technical principle: as physically realizable scale gets ever smaller, synthesis techniques across a broad and diverse range of initiatives become increasingly similar, due to the atomic composition and properties of matter and the principles of quantum physics.

By way of illustration, in one preferred embodiment, referred to herein as the NMASS system (Nanoscale Modeling, Analysis, Simulation, and Synthesis), the scientific computing tools are intended for implementation on a desktop personal computer, with additional processing power provided as a utility resource from a grid-computing model, or similar. The system provides a computer-based environment for users to readily develop and implement customizable models of quantum, atomic, and molecular properties. These models derive their attributes from integrated databases, external interfaces, various forms of web services, and/or from user-definition.

Using the NMASS system, individual models (or groups of individual models) can be aggregated (static) and/or time-sequenced (dynamic) for the purposes of analysis, simulation, prediction, and visualization. The system includes a computational engine and programming interface that provides users with the ability to simulate various combinatorial processes and to customize output formats.

The NMASS system features an analytical toolset that enables mathematical, behavioral, and functional modeling and characterization of physical and chemical phenomena by integrating object-oriented code blocks representing periodic table element templates, combinatorial processes, subatomic structures, material attributes, and various synthesis schema. The toolset includes organic and inorganic abstraction libraries from which static and/or dynamic models of biological, cellular, synthetic, and/or hybrid structures are developed for the purposes of design, analysis, simulation, and physical embodiment of products and processes for molecular assembly and/or nanoscale device manufacture. Given sufficient processing and data storage capacity, these same models can be extended to microfabrication applications.

The NMASS system also features a customizable driver interface for capturing empirical measurement data, including specific drivers for commercially available nanoscale instrumentation and methods, e.g., scanning tunneling, scanning probe, atomic force microscopy, and nuclear magnetic resonance. Other data capture devices, instrumentation, and methods can also be readily integrated.

The NMASS system also features a visualization/rendering engine compatible with commercially available graphic tools and methods, e.g., VRML, OpenGL, Flash, etc. The visualization tools can be used to create customized displays of nanoscale phenomena for graphical presentation.

Perhaps most importantly relative to the described invention, the NMASS system also features a real-time synthesis/fabrication closed-loop control procedural code block that can be readily integrated with the external sensor driver interfaces for certain suitable applications, e.g., nanoscale fabrication and molecular assembly. This code block can be generated using stored schema templates, internal control code development tools, externally implemented control theory computing software, or custom script or compiled software code provided by the operator.

The NMASS system also features an optional module for auto-generation of standardized documentation (e.g., engineering drawings, technical specifications, etc.) relating to particular industry applications.

### Brief Description of Drawings

The invention is described with specificity with the appended claims. The above and further advantages of this invention may be better understood by referring to the following description taken in conjunction with the accompanying drawings, in which:

FIG. 1 provides a block diagram overview of the NMASS system architecture.

FIG. 2 illustrates the computational environment and interfaces of FIG. 1.

FIG. 3 illustrates closed loop control and visualization tools of FIG. 1.

FIG. 4 depicts a sample process flowchart for the NMASS system.

FIG. 5 illustrates the NMASS system closed loop control compensator implementation for design and analysis.

### Detailed Description

Conventional commercial processes for silicon-based technologies like integrated circuits and micro-electromechanical machines (e.g., polysilicon surface micromachining, anodic and silicon-fusion bonding, photolithography, electroplating, etching and chemomechanical polishing) have inherent limitations at or near the micron level due to their top-down nature. The present invention describes a system and methodology wherein computer simulation is employed to generate analytical models of the quantum behavior and aggregate characteristics of various inorganic, organic, and hybrid materials. The computer simulation is pragmatically employed using a hardware-in-the-loop methodology and optimal control algorithms to complete a system for nanoscale synthesis.

In the preferred embodiment, the NMASS system 10 is comprised of software code and compiled libraries 14, and is intended for implementation on a desktop computer. Although certainly not limited to such implementation, a primary motivation for this consideration is the broad utility of the system applications and the intended user community ranging from academic research to product engineering in various industries. The NMASS system provides users with the ability to develop and implement high-fidelity digital representations of physical and chemical phenomena. The system includes a computational environment 50, intuitive user interface(s) 104, integrated software libraries 14, analytical tools 51, and visualization/rendering engine 108 that together provide an integrated framework for nanoscale modeling, analysis, simulation, and synthesis.

The compiled libraries 14 contain data that can be inherited into the analytical toolset models 51 based on user definitions. For a particular application (e.g. semiconductor analysis and synthesis), stored data from the libraries 14 contains mathematical models of particle dynamics and other related physiochemical and material attributes (e.g., stochastic/thermodynamic representative behavior of silicon, polymers, and/or other material and substrates). Characterizations generated from this stored data are focused on atomic (and subatomic when applicable) descriptions, but can be extended to bottom-up descriptions of bulk material processing (e.g., modeling material response to microfabrication techniques such as etching, lithographic processes, etc.), including thermal models and heat dissipation representations both during the synthesis process and for intended operation

In addition to basic mathematical computation, the computational engine 52 includes a differential equation solver for developing and integrating dynamic models for stochastic representation of particle spatial relationships and higher order states, i.e., velocity, acceleration, jerk, or partial derivative states relative to variables other than time. Monte Carlo analysis can be performed using simulated results and compared to empirical data, so as to reduce development time and costs associated with more traditional investigative research and development.

Using the dynamics models together with the material attribute database properties, the user is able to model physiochemical reactions and temporal phenomena to the desired level of fidelity. These models can then be validated through the integrated closed loop nanoscale control and sensor drivers (e.g., solution-phase chemical agents or interaction with various substrates). Therefore, the NMASS system provides an ideal interdisciplinary framework for integrating optimal linear/nonlinear control (in particular, Lyapunov, LQ, Mu-synthesis) 101, stochastic modeling, and parameter identification techniques over nanoscale device fabrication and molecular assembly.

The NMASS system allows users to capture and archive simulated and empirical results for use with further analysis or simulation. Therefore, the models and simulation results can form the basis of continued research, development, investigation, and synthesis trials.

In many industries, processes for fabrication, manufacturing, manipulation and assembly use top-down bulk raw material reduction to achieve high precision and small scale. In general, these processes are successful at achieving micron scale precision. Although these techniques are widely employed in various industries presently, a growing population within the scientific and engineering communities agree that the next major innovation in scale and precision will come from an entirely different approach. As considerations for synthesis and assembly cross micron level, the desire for further advancement will persist but the physical processes to achieve continued innovation require substantial change. Above micron level, physical matter can be sufficiently modeled in aggregate, but sub-micron design requires explicit consideration of quantum physics and the atomic composition of chemical matter. For design and analysis, this next quanta level (below 0.1 micron) known in the industry as "nanoscale," requires explicit rigorous mathematical treatment of quantum mechanics and particle physics.

The NMASS system features a unique combination of molecular mechanics, semi-empirical, and ab initio methods to deliver flexibility to the user for achieving the desired level of modeling fidelity while simultaneously meeting practical considerations for implementation. Computational complexity of ab initio methods, such as the numerical computation of the Schrödinger equation, often prevents practical implementation for larger scale aggregate structures. A primary technical innovation that makes the more computationally efficient of these methods available in the NMASS system is the use of density functional theory. Instead of using electron wavefunctions, 3-dimensional charge density is employed to perform more efficient computational analysis of molecular dynamics. Moreover, it is the novel combination of these methods conveniently packaged into an integrated software environment that makes the NMASS system truly innovative and, in principle, a uniquely powerful toolset in its class of scientific software.

For the NMASS system, molecular dynamics are described by a set of coupled differential equations based in a three axis orthogonal system. Torsion and cross-coupling effects result from changes in electromagnetic, covalent, and frictional forces linking the rectilinear motions and rotational dynamics during physiochemical reaction. Under static conditions these forces and moments generally reach stable equilibrium. For control of nanoscale fabrication and molecular assembly, these dynamics require explicit and rigorous model consideration.

Although molecular dynamics are in general nonlinear, and the control implementation may also include nonlinearities such as actuator saturation, linear design techniques and gain-scheduling provide a means for practical implementation. The basic advantage of optimal linear multivariable control is an exploitation of achievable stability in a multi-loop sense that leads to potential enhancements in performance or quality. Modern multivariable methods optimize performance by delivering robust multi-loop stability with the capability for enhanced performance than conventional methods. Gain-scheduled linear control of nonlinear systems has been demonstrated with macroscale designs as an effective means of governing complex physical system behavior.

Trim point linearization is the process of determining an equilibrium point in the nonlinear differential equations that describe molecular dynamics. One such model is presented in U.S. Pat. No. 5,553,004. At a fixed instant in time, an equilibrium point is referred to as a trim condition and small perturbations of the differential equation state variables yield a set of linear dynamic equations representative of the local nonlinear operating condition. Using this approach, gains can be calculated over sets of operating conditions and scheduled. The NMASS system provides a trim point linearization procedure for building such linearized models.

For assembly, quantum mechanical actuation can be achieved via substrates, chemical reagents, catalysts, and other control variables. The NMASS system provides various actuation models using first or second order linear differential equations. Nonlinear complex actuator models are available for system simulation and performance evaluation. The complex model has equations that represent all significant aspects of the physical system including friction, heating, effective loading, and electromechanical saturation. Nanoscale sensors are modeled with linear transfer functions. The objective of the control system design is to drive the quantum mechanical actuation system to provide stable accurate closed loop control over the desired molecular assembly process.

Modern multivariable linear optimal control theory offers various alternative formulations to achieve different objectives depending on the particular application. Associated with each design approach is an optimality condition based upon a weighted combination of system parameters (typically including states, control authority, etc.). Two approaches, Linear Quadratic (LQ) and H∞/µ-Synthesis, are discussed specifically herein due to their unique suitability to the problem as formulated using the NMASS system. Linear quadratic control uses a state regulator approach with guaranteed multi-loop stability and a fixed signal flow structure. Alternatively, H∞/µ-Synthesis provides high robustness to parameter uncertainty and unmodeled dynamics at the expense of controller complexity.

A general procedure for digital multivariable control system design typically includes synthesis of a continuous Linear Time Invariant (LTI) controller that achieves robust performance for the continuous plant dynamics. For practical consideration, the NMASS system provides a mathematical procedure for discretizing the continuous LTI controller at a specified sampling rate suitable for implementation on a digital processor. H∞/µ controllers often acquire high frequency eigenvalues due to the formulation of the weighting functions and performance objectives. In macroscale design, these high frequency dynamics often do not contribute substantially to the ability to deliver robust performance, and model reduction techniques are an effective means of constructing a controller state representation suitable for digitization by removal of higher frequency states. In nanoscale design, such reduction is not always possible resulting in increased sampling rates and processor loading over other methods like LQ.

Using the NMASS system computational engine, linear quadratic control minimizes an infinite time integral cost functional in which the relative importance of the system states and controls are traded off against each another. Inherent properties of LQ full-state feedback include guaranteed closed loop asymptotic stability with ample stability margin for digital implementation.

Most fundamental to achieving desired closed loop response from the LQ controller is the selection of state and control weighting matrices. As opposed to conventional single loop design methods that employ pole placement, the LQ formulation is analytically solved in the time domain and the state and control weighting matrices define the relative scalings among system parameters. Due to the high dimensionality of the problem, the NMASS system provides an automated optimization procedure for the selection of weighting function matrix elements. Once appropriate weighting parameters are selected, the LQ controller is generated, digitized, and evaluated using full-spectrum (over full range of Nyquist frequency) high fidelity discrete linear/tolerance analysis.

In contrast with LQ, the NMASS H∞/µ formulation is developed and solved analytically in the frequency domain. In particular, the H∞/µ control approach provides a rigorous means to include parametric uncertainty in the molecular models for the optimized controller synthesis. Indeed, a driving theoretical conclusion and necessary foundation for the derivation H∞/µcontrol is a multi-loop vector generalization of the single-loop traditional Nyquist stability criterion, the basic premise behind all classical control theory including the analysis methods of Bode, Hurwitz, and Nichols. In this respect, H∞/µ control involves multi-loop generalizations of many classical design techniques. In the context of molecular manipulation, one distinct advantage of the H∞/µ formulation is a natural framework to parameterize uncertain characteristics in the system with robustness to such perturbations accounted for directly by the controller design methodology. The H∞ approach employs a natural extension to linear fractional transformations (LFTs) and structured singular values (SSV or µ) to rigorously handle perturbations directly in the optimal linear controller synthesis.

Similar to LQ, the H∞ formulation is solved by a pair of algebraic Riccati equations, the primary difference being that the H∞ solution is non-unique but can be parameterized for iterative numerical optimization. Using such an input-output approach to control system design, signal and system norms provide a means of characterizing system behavior. By mapping stability and performance objectives into intuitive characterizations of system signals, bounds are placed on system dynamics and desired closed loop behavior achieved. Thus, nanoscale fabrication and molecular assembly for many applications are achievable and facilitated using this approach.

Using the NMASS system, the operator defines a set of admissible perturbations, and a block diagonal uncertainty transfer matrix structure is formulated comprising all plant variations augmented by nominal performance objectives. Performance objectives are formulated as weighting functions on state variables and control signals. Minimization of the closed loop structured singular value defines the desired optimality condition (referred to as µ-Synthesis with an H∞ norm bound).

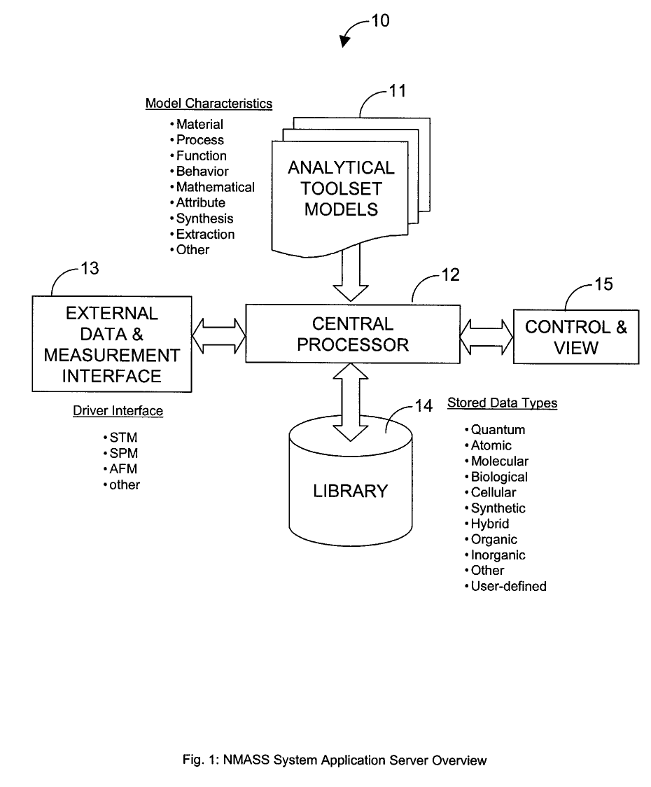

FIG. 1 provides an overview of the application server for the NMASS system 10. The analytical toolset models 11 are used to generate quantum models of the selected material properties. A central processor 12 enables mathematical simulation and integration with external data and measurements 13, stored data libraries 14, and visualization control and view 15. This architecture enables computational processing of various methods to represent the physical and chemical properties for a particular application. For example, depending on the desired level of fidelity, applied methods can be computationally intensive ab initio techniques, or make use of advances in quantitative modeling from density functional theory or even more recent advances and modifications to methods in mass spectroscopy (e.g., see 2002 Nobel Prize in Chemistry awarded to John B. Fenn and Koichi Tanaka for methods of electrospray ionization and soft laser desorption) to investigate and analyze molecular structure. Such methods can be used to generate quantitative and structural models compatible for integration with the NMASS system's tools and functionality.

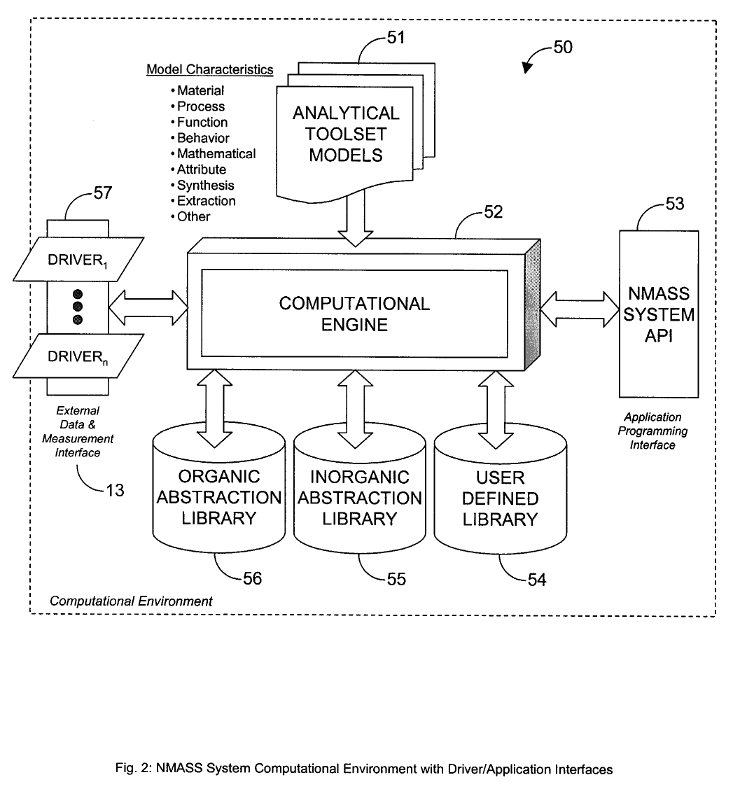

FIG. 2 provides an exploded view of FIG. 1. Explicit system architecture relationships are illustrated for the analytical toolset models 51, the computational engine 52, libraries for organic models 56, inorganic models 55, and user-defined models 54, along with the primary physical interfaces for the system integration of external data and measurement devices 57, and the NMASS system application programming interface (API) 53.

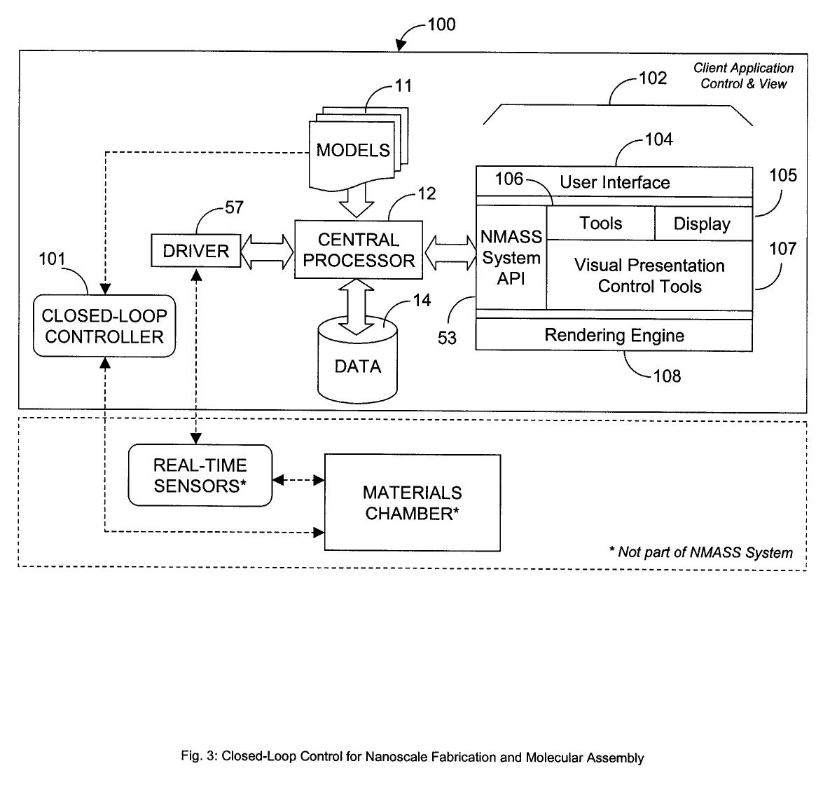

FIG. 3 illustrates the extension of the system to include the visualization application 102 and closed-loop control 101. The visualization engine is comprised of the NMASS API 53, a user interface 54 for providing operator control, data tools 106 and a display module 105 for enabling visual presentation of measurements or modeled phenomena using the visualization presentation control tools 107, and a rendering engine 108 for efficient processing of related imagery.

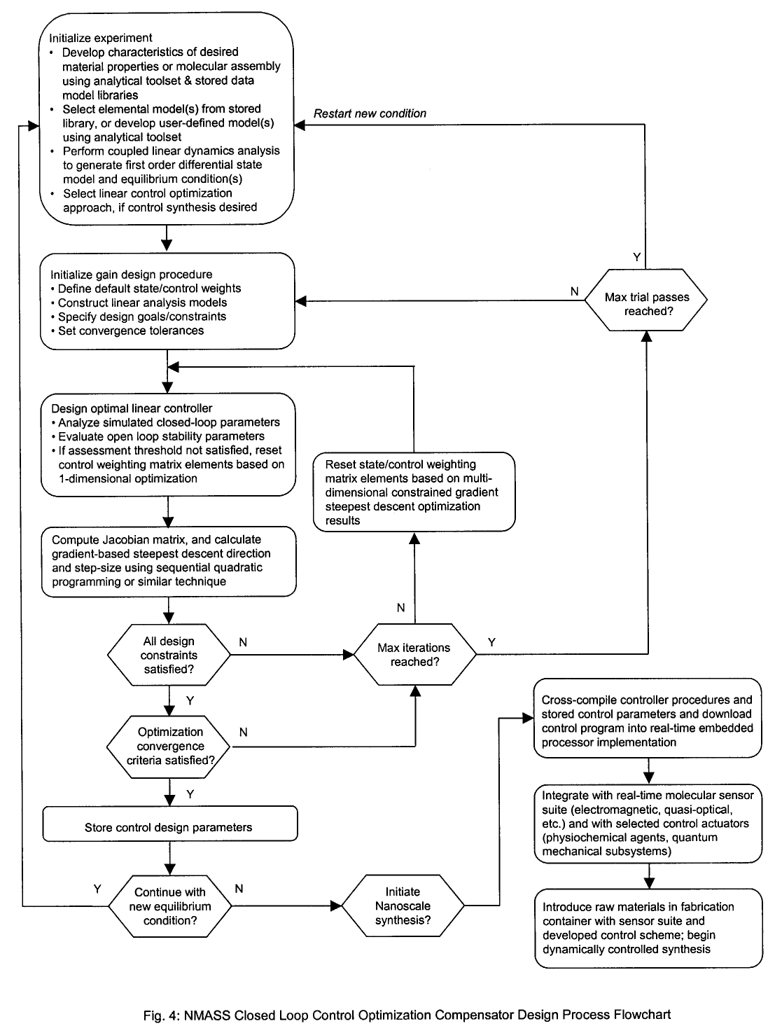

FIG. 4 provides a flowchart diagram for the NMASS system to illustrate a design cycle from concept through initial prototype.

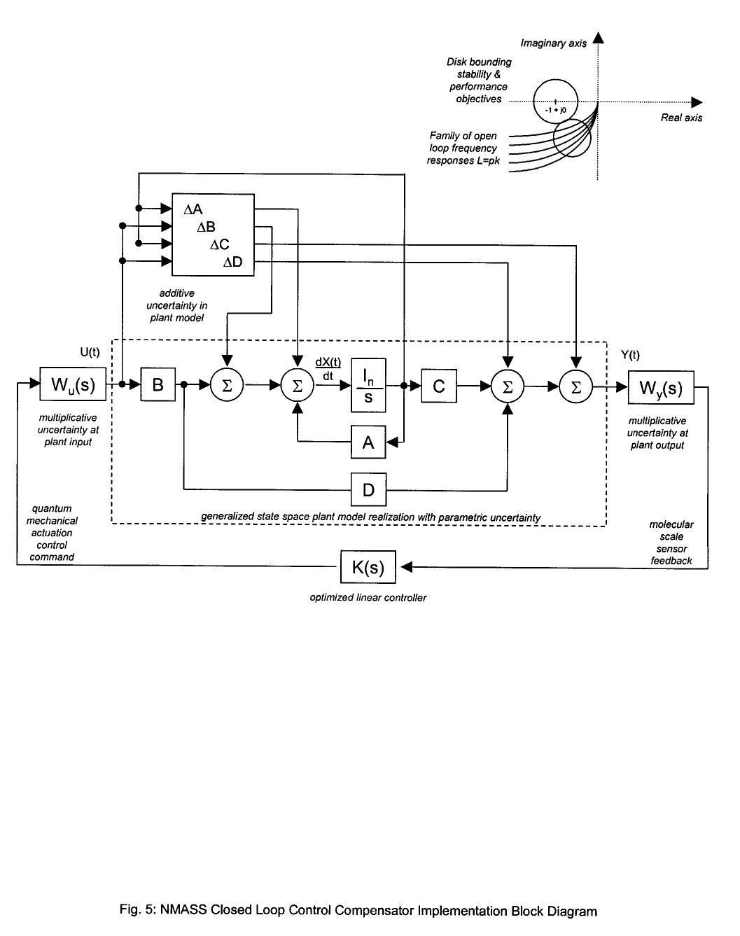

FIG. 5 provides a block diagram illustrating the implementation of the optimized linear controller for design and analysis with modeled plant dynamics including an explicit structure for parametric uncertainty in the molecular simulation. The plant uncertainty includes additive and multiplicative statistical error representing the stochastic behavior of the molecular dynamics and quantum mechanics underlying the state space plant model.

Having described and shown the preferred embodiments of the invention, it will now become apparent to one skilled in the art that other embodiments incorporating the concepts may be used and that many variations are possible which will still be within the scope and spirit of the claimed invention. Therefore, these embodiments should not be limited to disclosed embodiments but rather should be limited only by the spirit and scope of the following claims.

Claims

1. A computer-based system for nanoscale modeling, analysis, simulation, and synthesis, the system comprising: (a) One or more related computer programs, device drivers, and application programming interfaces to external computational resources and data storage utilities, that together implement a combination of executable procedures representing advanced mathematics from quantum theory, chemical physics, stochastic analysis, and optimal control; (b) A system architecture and implementation that accomplishes diverse industry applications by connecting to different databases, installing specialized templates, and integrating with various related sensor and synthesis hardware; (c) A storage utility for capturing, archiving, and querying data relevant to analytical simulation results and empirical experimentation; (d) A synthesis engine and interface to drive control commands to desired external resources for nanoscale fabrication and/or molecular assembly.

2. The system of claim 1 further comprising a rendering utility capable of presenting visual presentation of various data-driven representations of physical form, structure, and dynamic phenomena.

3. The system of claim 1 further comprising an analytical toolset that enables mathematical, behavioral, and functional modeling and characterization of physical and chemical phenomena by integrating object-oriented code blocks representing periodic table element templates, combinatorial processes, subatomic structures, material attributes, and various synthesis schema.

4. The system of claim 1 further comprising organic and inorganic abstraction libraries from which static and/or dynamic models of biological, cellular, synthetic, and/or hybrid structures are developed for the purposes of design, analysis, simulation, and physical embodiment of products and processes for molecular assembly and/or nanoscale device manufacture.

5. The system of claim 1 further comprising a customizable driver interface for capturing empirical measurement data, including specific drivers for commercially available nanoscale instrumentation, e.g., scanning tunneling, scanning probe, and atomic force microscopy and sensor devices/approaches of similar resolution.

6. The system of claim 1 further comprising a visualization/rendering engine compatible with commercially available graphic tools and methods, e.g., VRML, OpenGL, Flash, etc. The visualization tools can be used to create customized displays of nanoscale phenomena for graphical presentation.

7. The system of claim 1 further comprising a real-time synthesis/fabrication closed-loop control procedural block that can be readily integrated with the external sensor driver interfaces for certain suitable applications, e.g., nanoscale fabrication and molecular assembly. This code block can be generated using stored schema templates, internal control code development tools, externally implemented control theory computing software, or custom script or compiled software code.

8. The system of claim 1 further comprising an optional module for auto-generation of standardized documentation (e.g., engineering drawings, technical specifications, etc.) relating to particular industry applications.

9. The system of claim 1 further comprising stored data from the libraries contains mathematical models of particle dynamics and other related physiochemical and material attributes (e.g., stochastic/thermodynamic representative behavior of silicon, polymers, and/or other material and substrates).

10. The system of claim 1 further comprising characterizations generated from stored data focused on atomic (and subatomic when applicable) descriptions, but can be extended to bottom-up descriptions of bulk material processing (e.g., how materials respond to microfabrication techniques like etching, lithographic processes, etc.).

11. The system of claim 1 further comprising a differential equation solver for developing and integrating dynamic models for stochastic representation of particle spatial relationships and higher order states, i.e., velocity, acceleration, jerk, or partial derivative states with respect to variables other than time.

12. The system of claim 1 further comprising a Monte Carlo analysis procedure that can be performed using simulated results and compared to empirical data.

13. The system of claim 1 further comprising an optimal stochastic linear control synthesis methodology that incorporates a first order dynamic mathematical representation (of the conceptual molecular system) suitable for applying various pragmatic control system techniques including optimization of structured singular values, linear quadratic performance functions, Lyapunov criteria, or similar, for the purposes of nanoscale fabrication and molecular assembly.

14. 14 A method for determining the physiochemical characteristics of at least one type of material using nanoscale mathematical modeling, the method comprising: (a) One or more related computer programs, device drivers, and application programming interfaces to external computational resources and data storage utilities, that together implement a combination of executable procedures representing advanced mathematics from quantum theory, chemical physics, stochastic analysis, and optimal control; (b) A system architecture and implementation that accomplishes diverse industry applications by simply connecting to different databases, installing specialized templates, and integrating with various related sensor and synthesis hardware; (c) A storage utility for capturing, archiving, and querying data relevant to analytical simulation results and empirical experimentation (d) A synthesis engine and interface to drive control commands to desired external resources for nanoscale fabrication and/or molecular assembly.

15. The method of claim 14 wherein the model is a dynamic mathematical representation based on differential equations representing the quantum state of the at least one material, including reagents, solutions, or substrates, if applicable, and wherein the model can be integrated relative to time to simulate dynamic properties of the material under at least one morphological condition.

16. The method of claim 15 wherein the differential equations are a first order approximation about an equilibrium point such that they are suitable for a gain-scheduled optimal linear control methodology including optimization of structured singular values, linear quadratic performance functions, Lyapunov criteria, or similar, for the purposes of nanoscale fabrication and molecular assembly.

17. The method of claim 14 further comprising the step of transmitting the characteristics of the at least one material type over an internet for additional processing, storage, or display.

18. 18 A system for monitoring the molecular manufacturing of nano-electronic devices such as semiconductors, programmable gate arrays, computational machines, and memory blocks, the system comprising: (a) One or more related computer programs, device drivers, and application programming interfaces to external computational resources and data storage utilities, that together implement a combination of executable procedures representing advanced mathematics from quantum theory, chemical physics, stochastic analysis, and optimal control, as related to nano-electronics;(b) A storage utility for capturing, archiving, and querying data relevant to analytical simulation results and empirical experimentation;(c) A synthesis engine and interface to drive control commands to desired external resources for nanoscale fabrication and/or molecular assembly, as related to nano-electronics.

19. The method of claim 18 further comprising at least one control methodology for active computer-implemented control of the molecular manufacturing process.
